(19) United States
(12) Patent Application Publication
(10) Pub. No.: US 2026/0034769 A1
(43) Pub. Date: Feb. 5, 2026

(54) GLAZING COMPRISING A FIRST AND SECOND CHANNEL-SECTION GLAZING ELEMENT

(71) Applicant: Bauglasindustrie GmbH, Schmelz/Saar (DE)

(72) Inventors: Herbert SCHÖBEN, Nohfelden (DE); Wolfgang DUTT, Wallerfangen (DE); Salvatore TABONE, Saarlouis (DE)

(73) Assignee: Bauglasindustrie GmbH, Schmelz/Saar (DE)

(21) Appl. No.: 18/998,590

(22) PCT Filed: Aug. 1, 2023
(86) PCT No.: PCT/EP2023/071315

§ 371 Date: Jan. 27, 2025

(30) Foreign Application Priority Data
Aug. 1, 2022 (GB) 2211196.7

(51) Int. Cl. B32B 17/10; B32B 17/02

(52) U.S. Cl. CPC B32B 17/1055; B32B 17/02; B32B 17/10055; B32B 2307/304

(57) ABSTRACT

Glazings including first and second channel-section glazing elements arranged to define a cavity in which an inner glazing element is located are described. An end of a first flange of the first channel-section glazing element is spaced apart from a web of the second channel-section glazing element by a first space. The inner glazing element includes a central portion, a first edge portion running along a first side of the central portion, and a second edge portion running along a second opposite side of the central portion. A first portion of the first edge portion is positioned in the first space and is compressed by the end of the first flange of the first channel-section glazing element being positioned relative to the web of the second channel-section glazing element to form the first space.

The present invention relates to a glazing having first and second channel-section glazing elements with an inner glazing element therebetween.

Glazing units comprising three spaced apart panes of glazing material are known in the art, such glazing units often being referred to as triple glazed windows. In such triple glazed windows each of the glazing elements. or panes. are usually planar sheets of glass.

Glazing elements are known having a profiled or channel-section configuration. A profiled or channel-section glazing element is made from a sheet or ribbon of glass and has at least one lateral edge bent upwards during manufacture. Usually both lateral edges are bent upwards during manufacture. Examples of making a channel-section glazing element are described in DE1496047A1. The upward facing portions of the channel-section glazing element are known in the art as “flanges” and the lower portion connected to the or each flange is known as a “web”. Since channel-section glazing elements are made from a continuous glass sheet or ribbon and cut to the desired length. the flanges are a continuation of the web and are at an angle thereto. Usually. the flanges are at an angle of substantially 90° to the web. A channel-section glazing element having two lateral flanges is often referred to as a U-profile glazing element because the channel-section glazing element has a U-shaped cross section.

EP 0 742 324 A1 describes a facade consisting of two rows of U-shaped glass sections, one row forming the inner skin with its bases and the other similarly forming the outer skin, such that the legs of the U′s fit one inside the other. Cavities are filled with thermal insulation and a heat reflecting layer is provided on one of the outwards facing surfaces of the skins and/or the thermal insulation. The U-sections may be positioned so that they abut each other, and the legs of the U-sections are joined with PVC scaling strips and/or silicone sealing members. Such glazing units have limited visible transparency due to the nature of the thermal insulation. Furthermore, the facades having three U-sections described in EP 0742 324 A1 are relatively thick (the thickness of such a facade being the distance between the surface facing the exterior of a building in which the facade is installed and the surface facing the interior of the building in which the facade is installed).

WO2005/033432A1 describes a translucent glazing panel comprising: (a) a thermoplastic panel comprising (i) an outer wall having an inner surface defining an internal channel, the internal channel having an internal volume, and (ii) at least one inner wall protruding from the inner surface into the internal channel, and (b) hydrophobic aerogel particles. the hydrophobic aerogel particles being disposed within the channel. Such glazing panels are translucent and are not able to be used in applications requiring low haze.

Glazings including glass sheets between channel-section glazing elements are described in WO2015/007899A2. The glass sheets are held in position using clips.

Glazings including at least one row of profiled glass sheets arranged next to one another, each with at least one web and at least one flange, and at least one multiple web plate made of plastic, arc described in EP3260621B1. The multiple web plates made of plastic are attached to a separate holding device and are not attached to the profiled glass sheets.

There is a need for an improved glazing unit that can be used in glazing applications where increased energy performance is required. The ability to retrofit such glazing units into existing glazing systems is desirable. The ability to be able to simplify the production and installation of such glazing units is also desirable.

Accordingly, the present invention provides from a first aspect a glazing comprising a first channel-section glazing element and a second channel-section glazing element, the first and second channel-section glazing elements each comprising a web and a first flange, the first flange running along a first lateral edge of the respective web, the first and second channel-section glazing elements being arranged such that an end of the first flange of the first channel-section glazing element faces the web of the second channel-section glazing element, the end of the first flange of the first channel-section glazing element being positioned at a distance relative to the web of second channel-section glazing element such that the end of the first flange of the first channel-section glazing element is spaced apart from the web of the second channel-section glazing element by a first space, wherein at least a portion of an inner glazing element is located between the web of the first channel-section glazing element and the web of the second channel-section glazing element, the inner glazing element comprising a central portion, a first edge portion running along a first side of the central portion and a second edge portion running along a second side of the central portion, the first side of the central portion being opposite the second side of the central portion, wherein a first portion of the first edge portion of the inner glazing element is positioned in the first space between the end of the first flange of the first channel-section glazing element and the web of the second channel-section glazing element; wherein the first portion of the first edge portion of the inner glazing element is compressed by the end of the first flange of the first channel-section glazing element being positioned relative to the web of the second channel-section glazing element to form the first space.

A glazing according to the present invention has an improved energy performance when compared to the same glazing without the inner glazing element. The inner glazing element helps improve the thermal insulation properties of the glazing.

When the first space is formed by positioning the end of the first flange of the first channel-section glazing element relative to the web of the second channel-section glazing element, the first portion of the first edge portion of the inner glazing element is compressed. Such positioning occurs when the glazing is being constructed. By having an inner glazing element having a first edge portion that is compressible provides an edge portion that may be used to form seal between the end of the first flange of the first channel-section glazing element and the web of the second channel-section glazing element.

Preferably the first portion of the edge portion of the inner glazing element is reversibly compressed, more preferably the first portion of the first edge portion of the inner glazing element is reversibly compressed such that upon increasing the distance of the first flange of the first channel-section glazing element relative to the web of the second channel-section glazing element such that the end of the first flange of the first channel-section glazing element is spaced apart from the web of the second channel-section glazing element by a second space, the first portion of the first edge portion of the inner glazing element expands to fill the second space.

Preferably the first portion of the edge portion of the inner glazing element is irreversibly compressed, more preferably the first portion of the edge portion of the inner glazing element is irreversibly compressed such that upon increasing the distance of the first flange of the first channel-section glazing element relative to the web of the second channel-section glazing element such that the end of the first flange of the first channel-section glazing element is spaced apart from the web of the second channel-section glazing element by a second space, the first portion of the first edge portion of the inner glazing element changes shape but does not expand to fill the second space, or the first portion of the first edge portion of the inner glazing element does not change shape.

Preferably the first and/or second edge portion of the inner glazing element is made from a resilient material.

Preferably the central portion of the inner glazing element is made from a first material having a first chemical composition and the first edge portion is made from a second material having a second chemical composition, wherein the first chemical composition is the same as the second chemical composition or different to the second chemical composition.

Preferably the first edge portion of the inner glazing comprises at least a first cavity, and wherein when the first portion of the first edge portion is compressed, the shape of the first cavity changes.

Preferably the first edge portion of the inner glazing element comprises a plastic material. Suitable plastic material includes at least one of polyvinyl chloride (PVC), polyethylene polycarbonate and acrylic.

Preferably the first edge portion of the inner glazing element comprises an elastomer. Suitable elastomeric material includes at least one of silicone rubber, ethylene propylene diene monomer (EPDM) or neoprene.

Preferably the first portion of the first edge portion of the inner glazing element comprises a resilient portion.

Preferably the first edge portion of the inner glazing element comprises a resilient portion.

Preferably the first edge portion of the inner glazing element comprises a fibre insulation material. Suitable fibre insulation material preferable comprise glass fibres and/or synthetic fibres. Suitably, the fibre insulation material allows light to pass therethrough, preferably being translucent.

Preferably the central portion of the inner glazing element comprises a plastic material, more preferably polyvinyl chloride, polyethylene polycarbonate or acrylic.

Preferably the central portion of the inner glazing element comprises an elastomer, more preferably silicone rubber, ethylene propylene diene monomer (EPDM) or neoprene.

Preferably the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element.

Preferably the central portion of the inner glazing element comprises a fibre insulation material Suitable fibre insulation material preferable comprise glass fibres and/or synthetic fibres.

Preferably the distance of the end of the first flange of the first channel-section glazing element from the web of second channel-section glazing element is greater than 1 mm and/or less than 50 mm, preferably greater than 1 mm and/or less than 30 mm.

Preferably the distance of the end of the first flange of the first channel-section glazing element from the web of second channel-section glazing element is greater than 1 mm and/or less than 20 mm, preferably greater than 1 mm and/or less than 10 mm.

Preferably the central portion of the inner glazing element is suitably sized to fill the space between the web of the first channel-section glazing element and the web of the second channel-section glazing element.

Preferably the glazing is arranged such that there is a first space between the central portion of the inner glazing element and the web of the first channel-section glazing element and/or a second space between the central portion of the inner glazing element and the web of the second channel-section glazing element.

Preferably the central portion of the inner glazing element comprises at least a first wall spaced apart from a second wall, the first and second walls of the central portion of the inner glazing element having at least one space therebetween.

Preferably the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element.

Such multi-wall construction plastic sheets are well known in the art, see for example DE2722817A1, EP0050462A1, DE202011003120U1, DE202011109408U1 and DE202011106659U1.

Preferably the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile.

Preferably the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile.

In some embodiments, prior to being compressed, the first portion of the first edge portion has a thickness between 10 mm and 30 mm, and/or after being compressed, the first portion of the first edge portion has a thickness between 1 mm and 10 mm, this thickness after being compressed being less than the thickness before being compressed.

In some embodiments, prior to being compressed, the first portion of the first edge portion of the inner glazing element has a circular cross-section and/or after being compressed, the first portion of the first edge portion of the inner glazing element has an elliptical cross-section.

In some embodiments the central portion is made from a first material having a first chemical composition and the first edge portion is made from a second material having a second chemical composition, wherein the first chemical composition is the same as the second chemical composition.

Preferably the first edge portion of the inner glazing element is integrally formed with the central portion of the inner glazing element.

Preferably the first edge portion is bonded to the central portion.

Preferably the first edge portion of the inner glazing element is bonded to the central portion of the inner glazing element by being fused therewith or thereto.

Preferably the first edge portion of the inner glazing element is thermally fused with or to the central portion of the inner glazing element.

Preferably the inner glazing element is formed by an extrusion process wherein the central portion and the first edge portion are formed by extruding the first material through a first die and the second material through a second die.

Preferably the first material and the second material are coextruded at the same time.

An inner glazing element formed by an extrusion process is referred to herein as an extruded inner glazing element.

Preferably the inner glazing element is an extruded inner glazing element.

Preferably the first edge portion of the inner glazing element is bonded to the central portion of the inner glazing element by an adhesive, more preferably a permanent adhesive or a re-stickable adhesive.

Preferably the first edge portion of the inner glazing element is bonded to the central portion of the inner glazing element by a mechanical fastener, more preferably a hook and loop fastener.

In some embodiments the central portion is made from a first material having a first chemical composition and the first edge portion is made from a second material having a second chemical composition, wherein the first chemical composition is different to the second chemical composition.

Preferably the first edge portion of the inner glazing element is integrally formed with the central portion of the inner glazing element.

Preferably the first edge portion of the inner glazing element is bonded to the central portion of the inner glazing element.

Preferably the first edge portion of the inner glazing element is bonded to the central portion of the inner glazing element by being fused therewith or thereto.

Preferably the first edge portion of the inner glazing element is thermally fused with or to the central portion of the inner glazing element.

Preferably the inner glazing element is formed by an extrusion process wherein the central portion of the inner glazing element and the first edge portion are formed by extruding the first material through a first die and the second material through a second die.

Preferably the first material and the second material are coextruded at the same time.

A suitable extrusion process is described in U.S. Pat. No. 4,884,616.

Preferably the inner glazing element is an extruded inner glazing element.

Preferably the first edge portion of the inner glazing element is bonded to the central portion of the inner glazing element by an adhesive, more preferably a permanent adhesive or a re-stickable adhesive.

Preferably the first edge portion of the inner glazing element is bonded to the central portion of the inner glazing element by a mechanical fastener, more preferably a hook and loop fastener.

In embodiments where the first edge portion of the inner glazing element is bonded to the central portion of the inner glazing element by being thermally fused therewith or thereto, thermal fusion is preferably achieved using welding.

In some embodiments the first edge portion of the inner glazing element is integrally formed with the central portion of the inner glazing element.

Preferably the inner glazing element is an extruded inner glazing element.

Preferably the inner glazing element is made of a fibre insulation material, more preferably a fibre wool material comprising a bunch of fibres. Suitable fibres include synthetic fibres and glass fibres.

In some embodiments an end of the first flange of the second channel-section glazing element faces the web of the first channel-section glazing element such that the end of the first flange of the second channel-section glazing element is positioned at a distance relative to the web of second channel-section glazing element such that the end of the first flange of the second channel-section glazing element is spaced apart from the web of the first channel-section glazing element by a second space.

Preferably a first portion of the second edge portion of the inner glazing element is positioned in the second space between the end of the first flange of the second channel-section glazing element and the web of the first channel-section glazing element, preferably wherein the first portion of the second edge portion of the inner glazing element is compressed by the end of the first flange of the second channel-section glazing element being positioned relative to the web of the first channel-section glazing element to form the second space.

In embodiments where the web of the first channel-section glazing element has a second flange running along a second lateral edge thereof, the second lateral edge of the web of the first channel-section glazing element being opposite the first lateral edge of the web of the first channel-section glazing element, preferably the first flange of the second channel-section glazing element is received in the space between the first and second flanges of the first channel-section glazing element.

In some embodiments the web of the first channel-section glazing element has a second flange running along a second lateral edge thereof, the second lateral edge of the web of the first channel-section glazing element being opposite the first lateral edge of the web of the first channel-section glazing element, preferably wherein the first channel-section glazing element has a U-shaped profile; and the web of the second channel-section glazing element has a second flange running along a second lateral edge thereof, the second lateral edge of the web of the second channel-section glazing element being opposite the first lateral edge of the web of the second channel-section glazing element, preferably wherein the second channel-section glazing element has a U-shaped profile; and an end of the first flange of the first channel-section glazing element faces an end of the first flange of the second channel-section glazing element and an end of the second flange of the first channel-section glazing element faces an end of the second flange of the second channel-section glazing element.

Preferably the first edge portion of the inner glazing element comprises a first connection portion, and the first connection of the first edge portion of the inner glazing element is in mechanical communication with the first flanges of the first and second channel section glazing elements, preferably wherein the first connection portion of the first edge portion of the inner glazing element is attached to the first flanges of the first and second channel section glazing elements.

Preferably the second edge portion of the inner glazing element comprises a second connection portion and wherein the second connection portion of the inner glazing element is in mechanical communication with the second flanges of the first and second channel-section glazing elements, preferably wherein the second connection portion of the inner glazing element is attached to the second flanges of the first and second channel section glazing elements.

In some embodiments the glazing further comprises a third channel-section glazing element comprising a web and a first flange running along a first lateral edge thereof, the glazing being arranged such that the first flange of the first channel-section glazing element faces the web of the third channel-section glazing element; the first flange of the second and third channel-section glazing elements faces the web of the first channel-section glazing element, and wherein the first flange of the third channel-section glazing element is between the first flange of the first channel-section glazing element and the first flange of the second channel-section glazing element.

Preferably the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile; and wherein the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile; wherein the second flange of the first channel-section glazing element faces the web of the second channel-section glazing element.

Preferably the first edge portion of the inner glazing element comprises a first connection portion, wherein the first connection portion of the first edge portion of the inner glazing element is in mechanical communication with the first flange of the second channel-section glazing element and/or the first flange of the third channel-section glazing element, preferably wherein the first connection portion of the first edge portion of the inner glazing element is attached to the first flange of the second channel-section glazing element and/or the first flange of the third channel-section glazing element.

Preferably the glazing further comprises a fourth channel-section glazing element comprising a web and a first flange running along a first lateral edge thereof, the glazing being arranged such that the first flange of the fourth channel-section glazing element faces the web of the second channel-section glazing element; and wherein the first flange of the fourth channel-section glazing element is between the second flange of the first channel-section glazing element and the second flange of the second channel-section glazing element.

Preferably the second edge portion of the inner glazing element comprises a second connection portion and wherein the second connection portion of the second edge portion of the inner glazing element is in mechanical communication with the second flanges of the first and second channel-section glazing elements, preferably wherein the second connection portion of the second edge portion of the inner glazing element is attached to the second flanges of the first and second channel section glazing elements.

Preferably the second connection portion of the second edge portion of the inner glazing element is in mechanical communication with the first flange of the fourth channel-section glazing element, preferably wherein the second connection portion of the second edge portion of the inner glazing element is attached to the first flange of the fourth channel-section glazing element.

Other embodiments have other preferable features.

Preferably the web of the first channel-section glazing element has a second flange running along a second lateral edge thereof, the second lateral edge of the web of the first channel-section glazing element being opposite the first lateral edge of the web of the first channel-section glazing element. Preferably the first and second flanges of the first channel-section glazing element both project in the same direction away from the web.

Preferably the web of the second channel-section glazing element has a second flange running along a second lateral edge thereof, the second lateral edge of the web of the second channel-section glazing element being opposite the first lateral edge of the web of the second channel-section glazing element. Preferably the first and second flanges of the second channel-section glazing element both project in the same direction away from the web.

The web of the first channel-section glazing element has a first major surface and a second opposing major surface. Preferably at least a portion of the first and/or second major surface of the web of the first channel-section glazing element has a coating thereon. Preferably the coating is a low emissivity coating. Preferably the coating is a solar control coating.

The web of the second channel-section glazing element has a first major surface and a second opposing major surface. Preferably at least a portion of the first and/or second major surface of the web of the second channel-section glazing element has a coating thereon. Preferably the coating is a low emissivity coating. Preferably the coating is a solar control coating.

In a preferred embodiment the glazing the first and second channel-section glazing elements each comprise a web, a first flange and a second flange, the first flange running along a first lateral edge of the respective web and the second flange running along a second lateral edge of the respective web, the first lateral edge of the web being opposite the second lateral edge of the web, the first and second channel-section glazing elements being arranged such that the first flange of the first channel-section glazing element faces the first flange of the second channel-section glazing element and the second flange of the first channel-section glazing element faces the second flange of the second channel-section glazing element. In this arrangement preferably the first flange of the first channel-section glazing element is coplanar with the first flange of the second channel-section glazing element and the second flange of the first channel-section glazing element is coplanar with the second flange of the second channel-section glazing element.

Preferably the inner glazing element extends between the first and second flanges of the first channel-section glazing element.

Preferably the inner glazing element extends between the first and second flanges of the second channel-section glazing element.

Preferably the first and second channel-section glazing elements are separated by a gap and the inner glazing element is positioned in the gap.

In embodiments where the first channel-section glazing element has first and second flanges, preferably the first flange of the second channel-section glazing element is received in the space between the first and second flanges of the first channel-section glazing element.

In some embodiments the web of the first and/or second channel-section glazing element is curved or corrugated, for example as in the channel-section glazing elements described in WO2008068324A1.

In some embodiments, the first channel-section glazing element is made of annealed glass and not thermally toughened glass, the second channel section glazing element is made of annealed glass and not thermally toughened glass.

In other embodiments, the first channel-section glazing element is made of annealed glass and not thermally toughened glass, the second channel section glazing element is made of annealed glass and not thermally toughened glass.

Glazings in accordance with the first aspect of the present invention have other preferable features.

Preferably the central portion of the inner glazing element is monolithic.

Preferably the first and/or second channel-section glazing element is optically transparent.

Preferably the first and/or second channel-section glazing element is laminated.

Preferably the first and/or second channel-section glazing element is coated over at least a portion thereof to provide the respective channel-section glazing element with a region having a different colour in reflected or transmitted light compared to the uncoated channel-section glazing element. Such a coating may be optically opaque. Suitably the coating is a paint.

Preferably the web of the first and/or second channel-section glazing element has a thickness between 4 mm and 12 mm, more preferably between 5 mm and 8 mm.

Preferably the or each flange of the first and/or second channel-section glazing element has a thickness of between 4 mm and 12 mm, more preferably between 5 mm and 8 mm.

Preferably the thickness of the web of the first channel-section glazing element is the same as the thickness of the or each flange of the first channel-section glazing element.

Preferably the thickness of the web of the second channel-section glazing element is the same as the thickness of the or each flange of the first channel-section glazing element.

Suitable coatings that may be useful with glazings according to the present invention include low-emissivity coatings, conductive coatings, and solar control coatings. A low emissivity coating is a coating which when applied to clear, 3 mm thick float glass, results in the coated glass having an emissivity in the range of 0.05 to 0.45, the actual value being measured in accordance with EN 12898 (a published standard of the European Association of Flat Glass Manufacturers). Suitably a low emissivity coating comprises at least one layer comprising tin oxide.

Typical solar control coatings comprise layers of silver or tin oxide and control the amount of heat absorbed through the coated glass. Solar control and low emissivity coatings may also be electrically conductive, and so not only provide functionality to the glass in terms of emissivity and heat transmission but can form an electrically conductive substrate for mounting electrically conductive devices.

Such coatings may be applied using techniques known in the art. for example atmospheric pressure chemical vapour deposition or spray pyrolysis.

When the first and/or second channel-section glazing element has two flanges, preferably the thickness of each flange is the same.

In embodiments where the inner glazing element has a central portion having a multi-wall construction, preferably at least one of the walls of the central portion has a thickness less than about 5 mm and/or a thickness greater than 0.05 mm. The thickness of at least one of the walls of the central portion may be between 0.5 mm and 3 mm.

In embodiments where the first edge portion of the inner glazing element has a first connection portion preferably having a multi-wall construction. preferably at least one of the walls of the first connection portion has a thickness less than about 5 mm and/or a thickness greater than 0.05 mm. The thickness of at least one of the first connection portion may be between 0.5 mm and 3 mm.

In embodiments where the second edge portion of the inner glazing element has a second connection portion preferably having a multi-wall construction. preferably at least one of the walls of the second connection portion has a thickness less than about 5 mm and/or a thickness greater than 0.05 mm. The thickness of at least one of the first connection portion may be between 0.5 mm and 3 mm.

In embodiments where the inner glazing element has a central portion preferably having a multi-wall construction, preferably the central portion has a thickness between 5 mm and 500 mm, or 400 mm, or 300 mm, or 200 mm, or 100 mm. The central portion may have less than 50 walls extending along a first axis, the first axis preferably being parallel to the web of the first and/or second channel-section glazing element. The central portion preferably has a plurality of walls extending along a second axis, the second axis preferably being perpendicular to the web of the first and/or second channel-section glazing element.

In embodiments where the first edge portion of the inner glazing element has a first connection portion preferably having a multi-wall construction. preferably the first connection portion has a thickness between 1 mm and 200 mm. The first connection portion preferably has a plurality of walls extending along a first axis, the second axis preferably being perpendicular to the web of the first and/or second channel-section glazing element. The first connection portion preferably has a plurality of walls extending along a second axis, the second axis preferably being perpendicular to the web of the first and/or second channel-section glazing element.

In embodiments where the second edge portion of the inner glazing element has a second connection portion preferably having a multi-wall construction, preferably the second connection portion has a thickness between 1 mm and 200 mm. The second connection portion preferably has a plurality of walls extending along a first axis. the second axis preferably being perpendicular to the web of the first and/or second channel-section glazing element. The second connection portion preferably has a plurality of walls extending along a second axis, the second axis preferably being perpendicular to the web of the first and/or second channel-section glazing element.

In embodiments where the glazing is arranged such that there is a first space between the central portion of the inner glazing element and the web of the first channel-section glazing element and a second space between the central portion of the inner glazing element and the web of the second channel-section glazing element, the webs of the first and second channel-section glazing elements are spaced apart by a spacing and the central portion has a thickness less than the spacing between the webs of the first and second channel-section glazing elements.

Preferably the central portion has a thickness that is less than 90% of the spacing between the webs of the first and second channel-section elements, more preferably less than 80%, or 70% or 60%, or 50%, or 40%, or 30%, or 20%, or 10%, or 5% of the spacing between the webs of the first and second channel-section elements.

Preferably the central portion has a thickness that is at least 2% or 3% or 4% of the spacing between the webs of the first and second channel-section elements.

Preferably the central portion has a thickness between 0.5 cm and 50 cm, more preferably between 0.5 cm and 40 cm, or 30 cm, or 20 cm, or 10 cm, or 5 cm.

In some embodiments the first edge portion of the inner glazing element is bonded to the central portion of the inner glazing element by an adhesive.

Any suitable adhesive may be used. The adhesive may be a permanent adhesive or a re-stickable adhesive.

Prior to bonding the first edge portion of the inner glazing element to the central portion of the inner glazing element, the adhesive is preferably in sheet form or liquid form.

Examples of an adhesive in sheet form is a doubled sided adhesive tape.

It is most preferred that the adhesive be in liquid form.

Suitable adhesives include acrylic, anaerobic, cyanoacrylates, and epoxy adhesives.

The adhesive may be a hot melt adhesive. If the adhesive is a hot melt adhesive, the temperature used to provide the hot melt adhesive is preferably below a temperature that may cause the central portion or the first edge portion of the inner glazing element to degrade, deform or decompose.

When the second edge portion is bonded to the central portion of the inner glazing element, adhesive bonding as just described may be used to bond the second edge portion to the central portion of the inner glazing element.

In some embodiments the first edge portion of the inner glazing element is bonded to the central portion of the inner glazing element by a mechanical fastener.

Suitable mechanical fasteners include hook and loop fasteners such as Velcro type material.

When the second edge portion is bonded to the central portion of the inner glazing element, a mechanical fastener as just described in relation to the first edge portion of the inner glazing element being bonded to the central portion of the inner glazing element may be used.

In some embodiments the first edge portion of the inner glazing element is bonded to the central portion of the inner glazing element by being welded thereto.

Welding provides a means of thermally fusing the first edge portion of the inner glazing element to the central portion of the inner glazing element.

When the first material and second material are a plastic material, plastic welding may be used to bond the first edge portion of the inner glazing element to the central portion of the inner glazing element.

When the second edge portion is bonded to the central portion of the inner glazing element, welding as just described in relation to the first edge portion of the inner glazing element being welded to the central portion of the inner glazing element may be used.

In some embodiments the first edge portion of the inner glazing element is bonded to the central portion of the inner glazing element by being fused therewith or thereto.

Preferably the first edge portion of the inner glazing element is thermally fused to or with the central portion of the inner glazing element.

In these embodiments, to bond the first edge portion of the inner glazing element to the central portion of the inner glazing element, the temperature of at least a portion of the first edge portion of the inner glazing element is increased to soften the first material, and the heat softened portion of the first edge portion is contacted with the first side of the central portion of the inner glazing element to bond therewith.

Alternatively, or in addition to, to bond the first edge portion of the inner glazing element to the central portion of the inner glazing element, the temperature of at least a portion of the first side of the central portion of the inner glazing element is increased to soften the second material, and the heat softened portion of the central portion is contacted with the first edge portion to bond therewith.

If both the first edge portion and the central portion are heated to soften the first and second materials for bonding, the heat softened portions are preferably contacted together to enable bonding.

Fusion of the first edge portion of the inner glazing element with the central portion of the inner glazing element may occur when the inner glazing element is made, for example by using an extrusion process.

When the second edge portion is bonded to the central portion of the inner glazing element, the second edge portion may be fused to the central portion of the inner glazing element as just described in relation to the first edge portion of the inner glazing element being bonded to the central portion of the inner glazing element by being fused therewith.

In some embodiments the first edge portion of the inner glazing element is bonded to the central portion of the inner glazing element by being integrally formed therewith.

In such embodiments the inner glazing element is preferably formed by an extrusion process wherein the central portion and the first edge portion are formed by extruding the first material through a first die and the second material through a second die.

The first die and the second die are preferably part of a die assembly.

Preferably the first material and the second material are coextruded at the same time.

A suitable extrusion process is described in U.S. Pat. No. 4,884,616.

In such embodiments, it is preferred that the first edge portion of the inner glazing element is fused to or with the central portion of the inner glazing element.

When the second edge portion is bonded to the central portion of the inner glazing element, the second edge portion may be integrally formed therewith in the same way as just described when the first edge portion of the inner glazing element is integrally formed with the central portion of the inner glazing element.

In some embodiments the first and/or second edge portion of the inner glazing element is integrally formed with the central portion of the inner glazing element.

In some embodiments the central portion is made from a first material and the first edge portion is made from a second material, wherein the first material is harder than the second material.

The relative hardness of a material may be determined using a standard technique. for example as defined in ASTM D2240 type A and type D scales. Preferably the hardness of the first material, the second material and the third material are determined using a method as defined in ASTM D2240 type A and type D scales.

Hardness of a material may be measured using a known durometer scale.

Preferably the first material has a first Shore Hardness A and the second material has a second Shore Hardness A, wherein the first Shore Hardness A is greater than the second Shore Hardness A.

Preferably the Shore Hardness A of the second material is less than 120.

Preferably the Shore Hardness A of the first material is greater than 50.

Preferably the first material has a Shore hardness D of greater than 50.

Preferably the Shore Hardness A of the second material is greater than 10.

Preferably the first material has a Shore hardness D of less than 120.

The present invention also provides from a second aspect an inner glazing element for a glazing according to the first aspect of the present invention, the inner glazing element comprising: a central portion, a first edge portion running along a first side of the central portion; and a second edge portion running along a second side of the central portion, the first side of the central portion being opposite the second side of the central portion. the central portion of the inner glazing element having a first major surface, a second major surface and a thickness, the thickness of the central portion of the inner glazing element being the spacing of the first and second major surfaces of the central portion of the inner glazing element; the first edge portion of the inner glazing element having a thickness in a direction parallel to the thickness of the central portion of the inner glazing element, wherein the thickness of the first edge portion of the inner glazing element is less than the thickness of the central portion of the inner glazing element, further wherein the first edge portion of the inner glazing element is bonded to the central portion of the inner glazing element and/or integrally formed therewith; and wherein the first edge portion of the inner glazing element comprises at least a first compressible portion.

Preferably the first compressible portion of the first edge portion of the inner glazing element is reversibly compressible, such that upon applying a force to the first edge portion of the inner glazing element, the first edge portion of the inner glazing element having a shape, the shape of the first edge portion of the inner glazing element changes from a first shape to a second shape, and upon removing the applied force, the shape of the first edge portion of the inner glazing element returns to the first shape.

Preferably the second edge portion of the inner glazing element has a thickness in a direction parallel to the thickness of the central portion of the inner glazing element, wherein the thickness of the second edge portion of the inner glazing element is less than the thickness of the central portion of the inner glazing element; further wherein the second edge portion of the inner glazing element is bonded to the central portion of the inner glazing element and/or integrally formed therewith; and wherein the second edge portion of the inner glazing element comprises at least a first compressible portion.

Preferably the first compressible portion of the second edge portion of the inner glazing element is reversibly compressible, such that upon applying a force to the second edge portion of the inner glazing element, the second edge portion of the inner glazing element having a shape, the shape of the second edge portion of the inner glazing element changes from a first shape to a second shape, and upon removing the applied force, the shape of the second edge portion of the inner glazing element returns to the first shape.

Preferably the central portion of the inner glazing element comprises polycarbonate, polyester, or acrylic. A suitable polyester is polyethylene terephthalate (PET).

Preferably the central portion of the inner glazing element comprises a bunch of fibres or a fibre insulation material. Suitable fibres include glass fibres and/or synthetic fibres.

Preferably the first and/or second edge portions of the inner glazing element comprise polyvinyl chloride (PVC) ethylene vinyl acetate (EVA), polycarbonate, polyester, a polyolefin, an elastomer or polyurethane.

Preferably the first edge portion of the inner glazing element comprises at least a first cavity therein having a first shape, and wherein upon compressing the first edge portion having the first cavity therein, the shape of the first cavity in the first edge portion changes.

Preferably the second edge portion comprises at least a first cavity therein having a first shape, and wherein upon compressing the second edge portion having the first cavity therein, the shape of the first cavity in the second edge portion changes.

Preferably the first edge portion of the inner glazing element is bonded to the central portion of the inner glazing element.

Preferably the second edge portion of the inner glazing element is bonded to the central portion of the inner glazing element.

Preferably the first edge portion of the inner glazing element is integrally formed with the central portion of the inner glazing element.

Preferably the second edge portion of the inner glazing element is integrally formed with the central portion of the inner glazing element.

Preferably the inner glazing element is made using an extrusion process such that the inner glazing element is an extruded inner glazing element.

Preferably at least one of the central portion of the inner glazing element, the first edge portion of the inner glazing element and the second edge portion of the inner glazing element comprises a plastic material.

The invention will now be described with reference to the following figures (not to scale) in which,

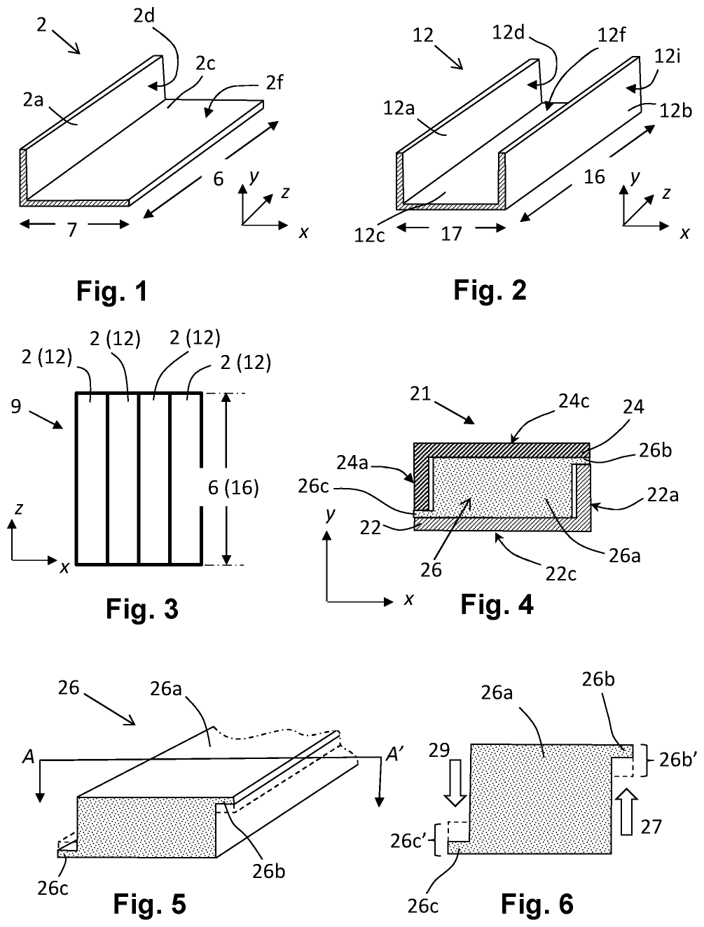

FIG. 1 is an isometric projection of a channel-section glazing element having only one flange continuous with a web;

FIG. 2 is an isometric projection of a channel-section glazing element having a web and two flanges continuous with the web;

FIG. 3 is a front view of a part of a facade for a building comprising four channel-section glazing elements;

FIG. 4 is a cross-sectional view of a glazing according to the present invention;

FIG. 5 is a schematic isometric view of part of the inner glazing element using in the glazing shown in FIG. 4;

FIG. 6 is a cross-sectional view of the inner glazing element used in the glazing shown in FIG. 4;

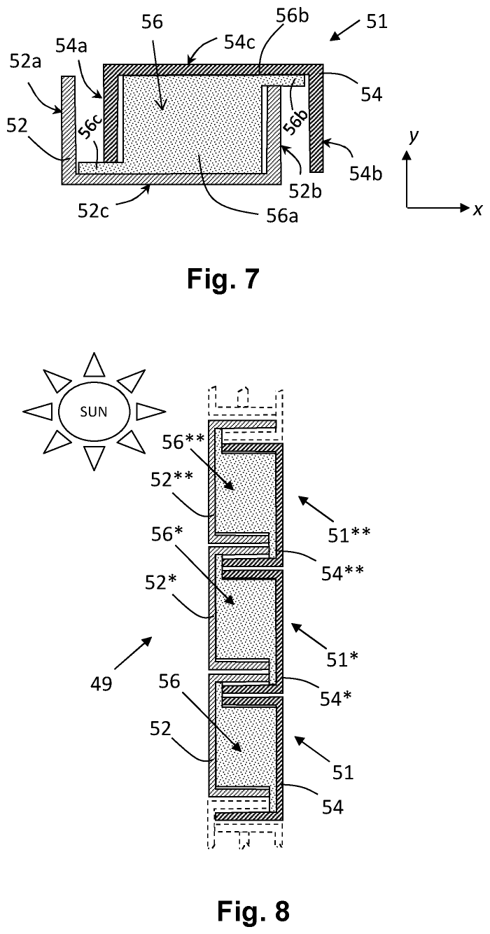

FIG. 7 is a cross-sectional view of another glazing according to the present invention;

FIG. 8 is a cross-sectional view of a facade comprising three glazings of the type shown in FIG. 7;

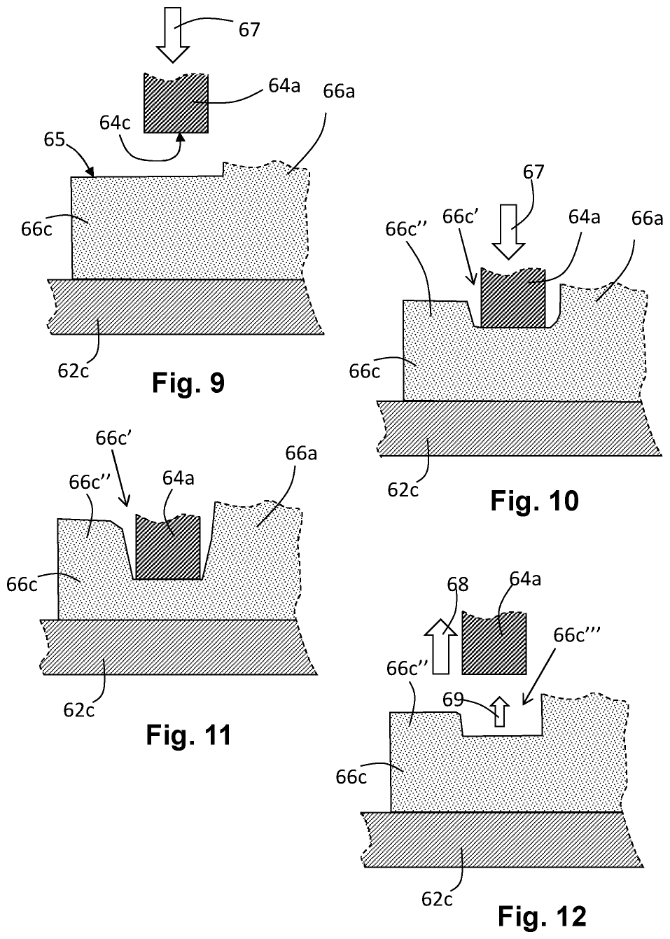

FIGS. 9-12 are cross-sectional views of a corner of a glazing of the type shown in FIG. 4 or FIG. 7 to illustrate the construction thereof;
another glazing according to the present invention;

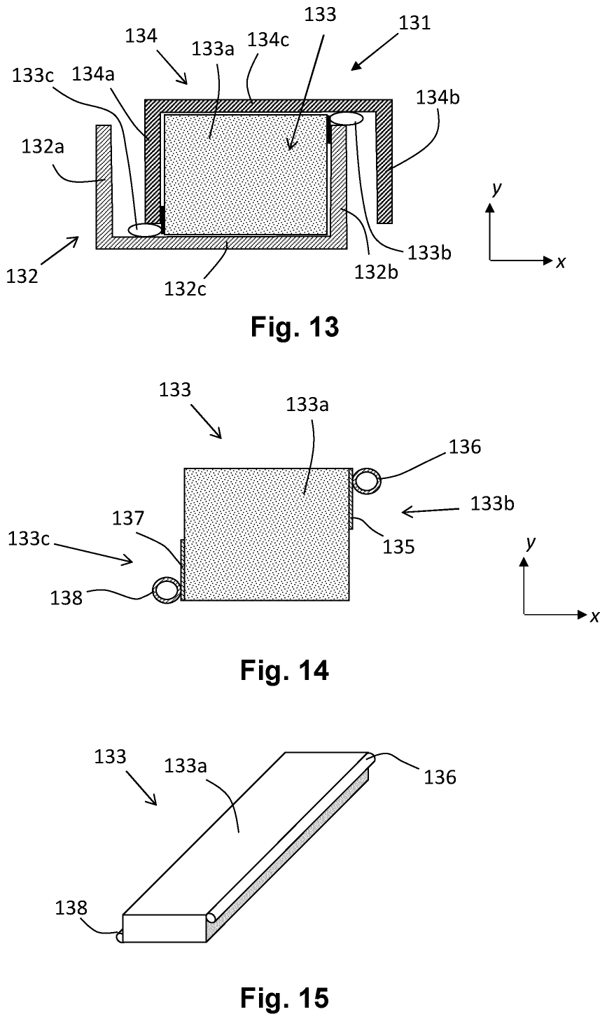

FIG. 13 is a cross-sectional view of another glazing according to the present invention;

FIG. 14 is a cross-sectional view of the inner glazing element used in the construction of the glazing shown in in FIG. 13; and

FIG. 15 is a schematic isometric representation of the inner glazing used in the construction of the glazing shown in FIG. 13.

FIG. 1 shows a schematic perspective view of one type of channel-section glazing element 2 that may be used in making a glazing in accordance with the present invention. The channel-section glazing element 2 has a flange 2a and a web 2c integrally formed therewith. The flange 2a is continuous with the web 2c and the channel-section glazing element 2 has been bent from an initially flat sheet or ribbon of glass, for example as described in DE1496047A1. The width 7 of the web may be many cm, whereas the length 6 of the web may be many tens of cm, up to several meters.

The flange 2a has a first major surface 2d and an opposing second major surface 2e (not indicated in the figure). The web 2c has a first major surface 2f and an opposing second major surface 2g (not indicated in the figure).

The flange 2a is substantially perpendicular to the web 2c. In this example the web 2c has a thickness of 7 mm and the flange 2a also has a thickness of 7 mm.

With reference to the co-ordinate system shown, the web 2c is parallel to the plane x-z. The flange 2a is parallel to the plane y-z. When viewed along the z-axis, the channel-section glazing element 2 has an “L” cross-sectional profile.

FIG. 2 shows a schematic perspective view of another type of channel-section glazing element 12 that may be used in making a glazing in accordance with the present invention.

The channel-section glazing element 12 has a first flange 12a, a second flange 12b and a web 12c. The flanges 12a, 12b are continuous (so integrally formed) with the web 12c and the channel-section glazing element 12 has been bent from an initially flat sheet or ribbon of glass, for example as described in DE1496047A1. The width 17 of the web may be many centimetres, whereas the length 16 of the web may be many tens of centimetres, up to several metres, for example 3 m to 10 m.

The first flange 12a has a first major surface 12d and an opposing second major surface 12e (not indicated in the figure). The second flange 12b has a first major surface 12h (not indicated in the figure) and an opposing second major surface 12i. The web 12c has a first major surface 2f and an opposing second major surface 12g (not indicated in the figure). The surface 12d of the first flange 12a faces the surface 12h of the second flange 12b.

The flanges 12a, 12b are each substantially perpendicular to the web 12c. In this example the web 12c has a thickness of 7 mm and the flanges 12a, 12b each have a thickness of 7 mm.

With reference to the co-ordinate system shown, the web 12c is parallel to the plane x-z. The flanges 12a, 12b are parallel to the plane y-z. When viewed along the z-axis, the channel-section glazing element 12 has a “U” cross-sectional profile.

The description of the channel-section glazing elements 2, 12 may be used in relation to the channel-section glazing elements described hereinafter.

FIG. 3 shows a front view of part of a facade 9 for a building comprising four channel-section glazing elements of the type described with reference to FIG. 1 or FIG. 2. With reference to FIG. 1 and FIG. 2, the facade is viewed in the direction of the y-axis.

As is known in the art, each channel-section glazing element 2 or 12 is arranged vertically in a supporting frame or mounting frame (not shown). For each channel-section glazing element 2 or 12 in the facade there may be suitable sealant material in between adjacent longitudinal edges.

The facade 9 may alternatively comprise horizontally orientated channel-section glazing elements.

FIG. 4 shows a cross-sectional view of a glazing 21 in accordance with the present invention. With reference to FIG. 1, this is a view in the direction of the z-axis.

The glazing 21 has a first channel-section glazing element 22 of annealed glass. The first channel-section glazing element 22 has a flange 22a and a web 22c. The flange 22a is continuous with the web 22c and the first channel-section glazing element has been bent from an initially flat sheet or ribbon of glass, for example as described in DE1496047A1.

The flange 22a is substantially perpendicular to the web 22c. The web 2c has a thickness of 7 mm. The flange 22a has a thickness of 7 mm.

The glazing 21 also has a second channel-section glazing element 24 of annealed glass. The second channel-section glazing element 24 has a flange 24a and a web 24c. The flange 24a is continuous with the web 24c and the first channel-section glazing element has been bent from an initially flat sheet or ribbon of glass, for example as described in DE1496047A1.

The flange 24a is substantially perpendicular to the web 24c. The web 24c has a thickness of 7 mm. The flange 24a has a thickness of 7 mm.

The second channel-section glazing element 24 has substantially the same dimensions as the first channel-section glazing element 22.

Both channel-section glazing elements 22, 24 are made of soda-lime-silica glass.

The first and second channel-section glazing elements are arranged such that the flange 22a of the first channel-section glazing element faces 22 faces the second channel-section glazing element 24, and the flange 24a of the second channel-section glazing element 24 faces the first channel-section glazing element 22. In this arrangement the inner facing surfaces of the channel-section glazing elements 22, 24 define a cavity.

The flange 22a has an end facing the web 24c and the flange 24a has an end facing the web 22c.

There may be a low emissivity coating on a surface of the web 22c and/or 24c facing into the cavity.

In accordance with the present invention the glazing 21 shown in FIG. 4 includes an inner glazing element 26 between the first channel-section glazing element 22 and the second channel-section glazing element 24. The inner glazing element 26 has a central portion 26a, a first edge portion 26b and a second edge portion 26c.

The first edge portion 26b is integrally formed with the central portion 26a on a first side, and the second edge portion 26c is integrally formed with the central portion 26a on a second side, the first side of the central portion 26a being opposite the second side of the central portion 26a.

The inner glazing element 26 is made of a fibre insulation material, such as mineral fibre wool, although any fibre like material may be used that provides suitable thermal insulation, for example glass fibre insulation material or synthetic fibre insulation material.

The first edge portion 26b is in contact with the end of the flange 22a facing the web 24c and the second edge portion 26c is in contact with the end of the flange 24a facing the web 22c.

The first edge portion 26b is compressed between the end of the flange 22a facing the web 24c and a portion of the web 24c. The second edge portion is compressed between the end of the flange 24a facing the web 22c and a portion of the web 22c.

The central portion 26a may be slightly compressed between the webs 22c, 24c but usually the central portion is suitably sized such that the central portion 26a is not compressed between the webs 22c, 24c.

The inner glazing element 26 is held in the correct position due to the clamping action between the end of the flange 22a facing the web 24c and a portion of the web 24c on the first edge portion 26b. There is also a clamping action between the end of the flange 24a facing the web 24c and a portion of the web 22c on the second edge portion 26c to hold the inner glazing element in the correct position.

The first (and second) edge portion 26b (26c) being in a compressed state adequately seals the space between the end of the flange 22a (24a) facing the web 24c (22c) and the web 24c (22c). This also provides a resilient or flexible seal that can move in the event of an impact on the web 22c and/or the web 24c, thereby providing both a seal and a shock absorber.

FIG. 5 shows a schematic isometric view of the inner glazing element 26 in the configuration shown in FIG. 4. That is, the first and second edge portions 26b, 26c are compressed. FIG. 5 also shows the position of the first and second edge portions when they are not compressed as a dotted line.

FIG. 6 shows a cross-sectional view of the inner glazing element through the plane A-A. FIG. 6 shows the first edge portion in the uncompressed state as portion 26b′ and the second edge portion in the uncompressed state as 26c′.

Applying a force in the direction of arrow 27 causes the uncompressed edge portion 26b to be compressed to the compressed first edge portion 26b as shown in FIG. 4. Applying a force in the direction of arrow 29 causes the uncompressed edge portion 26c to be compressed to the compressed second edge portion 26c as shown in FIG. 4.

The inner glazing element 26 has a length the same as that of the channel-section glazing elements 22, 24. The width of the inner glazing element 26 is about the same as the distance between the inner surfaces of the flanges 22a, 24a. The width of the inner glazing element 26 may be such that the inner glazing element is a snug fit between the flanges 22a, 24a.

With respect to the orientation of the glazing 21 as shown in FIG. 4, there may be an upper space between the web 24c and the central portion 26a of the inner glazing element and a lower space between the central portion 26a of the inner glazing element and the web 22c.

The central portion 26a has a thickness of about 10-20 cm. The first and second edge portions 26b, 26c have a thickness of about 5-10 mm in the compressed state.

The inner glazing element 26 may be formed by first providing a sheet of fibre insulation material, such as obtained from a roll of fibre wool. The sheet of fibre insulation material can then be cut to the appropriate dimensions. Thereafter, the edge portions can be removed by cutting to provide an inner glazing element having a central portion 26a with edge portions 26b′ and 26c′, as shown in FIGS. 5 and 6.

In an alternative embodiment, the first and second edge portions 26b, 26c′ may be provided separately and attached to the central portion 26a to provide the inner glazing 26 as shown in FIGS. 5 and 6. The edge portions 26b′, 26c′ may be attached to the central portion using a suitable adhesive, or a mechanical fastener. This alternative embodiment of providing the inner glazing element 26 has the advantage that the material of the central portion 26a can be chosen to have desirable thermal and/or light management properties, whereas the edge portions 26b′, 26c′ can be chosen to provide the inner glazing element with desirable properties to seal the space between the end of the flanges and the webs and/or provide suitable shock absorbing characteristics.

FIG. 7 shows a cross-sectional view of another glazing 51 in accordance with the first aspect of the present invention. With reference to FIG. 2, this is a view in the direction of the z-axis.

The glazing 51 has a first channel-section glazing element 52 having a first flange 52a, a second flange 52b and a web 52c. The flanges 52a, 52b are continuous with the web 52c and the first channel-section glazing element has been bent from an initially flat sheet or ribbon of glass, for example as described in DE1496047A1.

The glazing 51 also has a second channel-section glazing element 54 having a first flange 54a, a second flange 54b and a web 54c. The first channel-section glazing element 52 has the same dimensions as the second channel-section glazing element 54. This is advantageous because both the first and second channel-section glazing elements can be made during the same production run.

The first and second channel-section glazing elements are arranged such that and end of the flange 52b faces the flange 54c and an end of the flange 54a faces the web 52c. The first flange 54a is between the flanges 52a, 52b. The outer surface of the flange 54a is spaced from the inner surface of the flange 52a by a sufficient amount such that a flange of another glazing may be located therebetween (as will be described with reference to FIG. 8).

As a consequence of the first and second channel-section glazing elements having the same dimensions and because the flange 52a is spaced from the flange 54a, the flange 52b is spaced from the flange 54b. The space between the outer surface of flange 52b and the inner surface of flange 54b is sufficient that a flange of an adjacent glazing may be located therebetween.

The inner surfaces of the flanges 54a, 52b and portions of the inner surfaces of the webs 52c, 54c define a cavity in which is located an inner glazing element 56.

The inner glazing element 56 is similar to the inner glazing 26 described with reference to FIG. 4. The inner glazing element has a central portion 56a, a first edge portion 56b and a second edge portion 56c. The first edge portion 56b is integrally formed with the central portion 56a along a first side thereof. The second edge portion 56c is integrally formed with the central portion 56a along a second side thereof, the second side of the central portion 56a being along an opposite lateral edge of the central portion 56a to the first side of the central portion 56a. Consequently, the inner glazing element 56 has unitary form and may be referred to as a unitary inner glazing element.

The central portion 56a and the first and second edge portions 56b, 56c are made from a fibre insulation material such as a fibre mineral wool.

The central portion 56a of the inner glazing element 56 is located between the second flange 52b of the first channel-section glazing element 52 and the first flange 54a of the second channel-section glazing element 54.

As shown in FIG. 7. a portion of the first edge portion 56b is compressed by being clamped between the end of the flange 52b facing the web 54c and a portion of the web 54c. Also, a portion of the second edge portion 56c is compressed by being clamped between the end of the flange 54a facing the web 52c and a portion of the web 52c. The compressed portion of the first and second edge portions is about 5 mm thick but may be between 1 mm and 10 mm thick.

As can be seen in FIG. 7, a portion of the first edge portion 56b extends into the space between the flange 52b and the flange 54b. Likewise. a portion of the second edge portion 56c extends into the space between the flange 52a and the flange 54a. In the arrangement shown, the portions of the first and second edge portions 56b, 56c that extend into the space between the flanges 52b, 54, and 52a, 54a respectively are not compressed, but upon positioning a flange of a third channel-section glazing element into the space between the flanges 52b, 54b and a fourth channel-section glazing element into the space between the flanges 52a, 54a, compression of these portions of the first and second edge portion will occur. This is illustrated in more detail in FIG. 8.

There may be a low emissivity coating or a solar control coating on the surface of the web 52c, 54c facing away from central portion 56a of the inner glazing element 56.

The low emissivity coating may comprise tin oxide.

The central portion 56a of the inner glazing element 56 has a first major surface facing web 54c and a second major surface facing web 52c. There may be an air-space between the first major surface of the central portion 56a of the inner glazing element 56 and the web 54c and/or and air-space between the second major surface facing of the central portion 56a of the inner glazing element and the web 52c.

FIG. 8 shows a cross-sectional view of part of a facade 49 comprising a plurality of glazings 51. Each glazing 51 is positioned adjacent another glazing 51. To aid with the description of FIG. 8, three glazings 51, 51* and 51 ** are highlighted. Each glazing 51, 51* and 51* is the same as illustrated in FIG. 7, therefore each component part of glazing 51* and 51** will be referenced in the same way as for glazing 51 except with the addition of a “*” or “***” respectively after each component part. For example, glazing 51 has a first channel-section glazing element 52 having a first flange 52a. Glazing 51* therefore has a first channel-section glazing element 52* having a first flange 52a*, and so on. Likewise, glazing 51** has a first channel-section glazing element 52** having a first flange 52a**, and so on.

When installing the glazing to make facade 49, the second flange 54b* of glazing 51* fits into the space between the first flange 52a and the first flange 54a of glazing 51 such that the flange 52a faces the web 54c* of the second channel-section glazing element 54* of glazing 51*. Consequently, the flange 54b* of the second channel-section glazing element 54* of the glazing 51* faces the web 52c of the first channel-section glazing element 52 of the glazing 51.

As shown in FIG. 8, the second flange 54b** of glazing 51** fits into the space between the first flange 52a* and the first flange 54a* of glazing 51* such that an end of the flange 52a* faces the web 54c** of the second channel-section glazing element 54** of glazing 51**. Consequently, an end of the flange 54b** of the second channel-section glazing element 54** of the glazing 51** faces the web 52c* of the first channel-section glazing element 52* of the glazing 51*.

The glazings 51 forming the facade 49 may be vertically or horizontally orientated.

For each glazing 51 in the facade there may be suitable sealant material in between adjacent longitudinal edges.

As shown in FIG. 8, the webs 52c of each first channel-section glazing element 52 of each respective glazing 51 form the outer surface of the facade i.e. that surface facing the outside of the building in which the facade is installed. The inner facing surface is formed by the webs 54c of the second channel-section glazing element 54 of each respective glazing 51.

Due to the inclusion of an inner glazing element 56 in each glazing 51 (as described with reference to FIG. 7), the facade has improved thermal performance. The thermal performance can be improved further by the inclusion of a low emissivity coating on the webs of the first and/or second channel-section glazing elements.

Each inner glazing element 56, 56* and/or 56** may be the same or different.

As shown with reference to FIG. 7 and FIG. 8, the second flange 54b* of glazing 51* fits into the space between the first flange 52a and the first flange 54a of glazing 51 such that an end of the flange 52a faces the web 54c* of the second channel-section glazing element 54* of glazing 51*. Consequently, an end of the flange 54b* of the second channel-section glazing element 54* of the glazing 51* faces the web 52c of the first channel-section glazing element 52 of the glazing 51. As described above, an end of the flange 54a also faces the web 52c of the first channel-section glazing element 52 of the glazing 51.

The ends of the flanges 54a, 54b* are spaced apart from the web 52c by a first space. The edge second edge portion 52c in a compressed state is in the first space. The second edge portion 56c is therefore clamped between the ends of the flanges 54a, 54b* facing the web 52c and a portion of the web 52c.

The other edge portions of the inner glazing elements 56, 56* and 56** are clamped in a similar way.

FIGS. 9-12 show schematic cross-sectional view of a corner portion of a glazing similar to that shown in FIGS. 4 and 7. With reference to FIGS. 9-12, the glazing includes a first channel section glazing element having a web 62c and a second channel-section glazing element having a first flange 64a. With reference to FIGS. 4 and 7, the first flange 64a corresponds to the first flange 24a, 54a and the web 62c corresponds to the web 22c, 52c.

The glazing also includes an inner glazing element having a central portion 66a and an edge portion 66c. With reference to FIGS. 4 and 7, the inner glazing element corresponds to the inner glazing element 26, 56.

The flange 64a has an end 64c facing the web 62c. In this example, the end 64c is a flat surface, but the end may include at least one flat and/or at least one curved surface. The end 64c may comprise both curved and flat portions.

FIG. 9 shows the configuration of first and second channel-section elements with the inner glazing element having been positioned on the web 62c before the first flange 64a has been positioned in the final installed position.

By moving the first flange 64a towards the web 62c in the direction of arrow 67 (i.e. by moving the first and/or second channel-section glazing elements towards each other), the end 64c will contact the upper surface 65 of the edge portion 66c.

This is shown in FIG. 10 where the first flange 64a has been further moved in the direction of arrow 67 towards the web 62c. A portion 66c′ of the edge portion 66c is compressed between the end 64c of the first flange 64a and the web 62c. Another portion 66c″ of the edge portion 66c remains substantially uncompressed because the end 64c of the first flange 64a does not contact the upper surface 65 of the edge portion 66c in this region.

Continued movement of the first flange 64a towards the web 62c continues to compress the portion 66c′ until the final installation arrangement of the first and second channel-section glazing elements is reached. This is shown in FIG. 11. The portion 66c′ of the edge portion 66c has been compressed between the end 64c of the first flange 64a and the web 62c such that the edge portion 66c is essentially clamped between the end 64c of the first flange 64a and a portion of the web 62c. Prior to being compressed, the edge portion 66c has a thickness of about 20 mm, whereas in the configuration shown in FIG. 11, the compressed portion 66c′ has a thickness of about 5 mm. As is evident from FIG. 11, there is a first space between the end 64c of the first flange 64a and the web 62c. The compressed portion 66c′ of the edge portion 66c is in the first space.

The portion 66c″ remains substantially uncompressed, although there may be slight deformation of the interface region between the portion 66c′ and 66c″ and the interface region between portion 66c′ and the central portion 66a.

The portion 66c″ may be compressed by the provision of another channel-section glazing element as shown in FIG. 8. The flange of another channel-section glazing element may be used to compress the portion 66c″ in the same way as the first flange 64a creates the compressed portion 66c′.

FIG. 12 shows how the compressed portion may return to the original shape when the first flange 64a is removed from clamping contact with the edge portion 66c. Upon moving the flange 64a away from the web 62c in the direction of arrow 68, the compressed portion 66c′ moves in the direction of arrow 69 to fill the space created. In some embodiments, the compressed portion returns to the same shape before being compressed. In other embodiments, the compressed portion 66c′ becomes crushed such that the shape thereof is not able to return to the shape prior to being compressed.

In FIG. 12, the compressed portion has slightly returned to the shape before being compressed but has a shape slightly different therefrom. The portion 66c″′ is indented such that the upper surface 65 is no longer flat (as shown in FIG. 9).

FIG. 13 shows a cross-sectional view of another glazing 131 in accordance with the present invention. With reference to FIG. 2, this is a view in the direction of the z-axis. The glazing 131 is similar to the glazing 51 of FIG. 5.

The glazing 131 has a first channel-section glazing element 132 having a first flange 132a, a second flange 132b and a web 132c. The flanges 132a, 132b are continuous with the web 132c and the first channel-section glazing element has been bent from an initially flat sheet or ribbon of glass, for example as described in DE1496047A1.

The glazing 131 also has a second channel-section glazing element 134 having a first flange 134a, a second flange 134b and a web 134c. The first channel-section glazing element 132 has the same dimensions as the second channel-section glazing element 134. This is advantageous because both the first and second channel-section glazing elements can be made during the same production run.

The first channel-section glazing element 132 and second channel-section glazing element 134 are each of the type as described in relation to FIG. 2.

The first and second channel-section glazing elements 132, 134 are arranged such that an end of the first flange 134a faces the web 132c, and the first flange 134a is received in the space between the flanges 132a, 132b. The flanges 132a, 134a are sufficiently spaced apart such that a flange of another glazing may be located therebetween. An end of the second flange 132b faces the web 134c.

As a consequence of the first and second channel-section glazing elements 132, 134 having the same dimensions and because the flange 132a is spaced from the flange 134a, the flange 132b is spaced from the flange 134b. The flange 132b is sufficiently spaced apart from the flange 134b such that a flange of an adjacent glazing may be located therebetween.

The inner surfaces of the flanges 134a, 132b and portions of the inner surfaces of the webs 132c, 134c define a cavity in which is located an inner glazing element 133.

The inner glazing element 133 has a central portion 133a made of a fibre material such as mineral fibre wool or a bunch of fibres translucent to visible light. Along a first lateral edge of the central portion 133a a first edge portion 133b is bonded thereto. Along a second lateral edge of the central portion 133a a second edge portion 133c is bonded thereto. The first lateral edge or side of the central portion 133a is opposite the second lateral edge or side of the central portion. The first and second edge portion are each made of polyvinyl chloride (PVC), or an elastomer.

The first edge portion 133b comprises a hollow section that is compressed between the end of the flange 132b facing the web 134c and the web 134c. The second edge portion 133c also comprises a hollow section that is compressed between the end of the flange 134a facing the web 132c and the web 132c.

The inner glazing element 133 is shown in FIG. 14 prior to being assembled with the first and second channel-section glazing elements 132, 134 as shown in FIG. 13.

With reference to FIG. 14 the first edge portion 133b includes a flat sheet 135 of PVC bonded to the first lateral edge of the central portion 133a. The flat sheet of PVC may be provided on a first side with an adhesive or mechanical fastener to bond the flat sheet 135 to the first lateral edge of the central portion 133a. The flat sheet 135 of PVC has on an opposite side to the bonded side a tubular member 136 also of PVC. The flat sheet 135 and the tubular member 136 are preferably coextruded, but the tubular member 136 by be suitably bonded to the flat sheet 135 using other suitable bonding such as an adhesive, or plastic welding, or thermal fusing.

In the configuration shown in FIG. 14 the tubular member 136 has a circular cross-section with a wall thickness of about 1-2 mm and an external diameter of about 10-20 mm. The internal cavity of the tubular member 136 is circular in cross-section. When the tubular member 136 is compressed (as shown in FIG. 13), the cross-section changes shape (as does the shape of the internal cavity), for example becoming elliptical. The external diameter of the tubular member 136 is chosen to achieve the desired sealing between the end of the flange 132b facing the web 134c and the web 134c.

The second edge portion 133c is configured in the same way as the first edge portion 133b. The second edge portion 133c has a flat sheet 137 of PVC bonded to the second lateral edge of the central portion 133a on one side thereof, and on the opposite side thereof is a tubular member 138 also of PVC.

As shown in FIG. 14, the flat sheet 135 of PVC of the first edge portion 133b is bonded to the central portion 133a at an upper right corner region thereof; and the flat sheet 137 is bonded to the central portion 133a at a lower left corner region thereof.

The glazing 131 may be included in a facade of the type shown in FIG. 8.

FIG. 15 shows a schematic isometric representation of the inner glazing element 133 to illustrate the position of the tubular members 136, 138 relative to the central portion 133a.

By having the compressible first and second edge portions 133b and 133c, it is no longer necessary to have a separate gasket over the end of the flanges 132b, 134a. This simplifies assembly and reduces costs as one less component part is required.

In an alternative embodiment, the tubular member 136 (or 138) may be made from a different material to the flat sheet 135 (or 137). The flat sheet 135 may be made of a material with superior bonding to the central portion 133a, whereas the tubular member may be made of a material providing good sealing and compressibility. For example, the tubular member may be made of EPDM and the flat sheet may be made of a polyester such as PET.

In another alternative embodiment. the first edge portion 133b may be configured differently to the second edge portion 133c. The first edge portion 133b may be configured as the edge portion 26b shown in FIG. 6, or the edge portion 66c shown in FIGS. 9-12.

In another alternative embodiment, the central portion may be configured with at least one sheet of plastic such as polycarbonate. This may be in addition to a fibre insulation material, or instead of. For example, the central portion may comprise at least one sheet of polycarbonate having a multi-walled construction. Such a central portion may be tinted to provide a suitable colour, or a surface thereof may be provided with a coating such as a paint or a solar control coating.

In another alternative embodiment, the inner glazing element is made of plastic and the first and second edge portions are integrally formed with the central portion. The central portion may be multi-walled and the material of the first and second edge portions may have a different composition to the material of the central portion.

The present invention provides a glazing comprising two channel-section glazing elements that includes an inner glazing element to improve the thermal performance of the glazing. By having an inner glazing element wherein at least one edge portion thereof is compressed between an end of a flange facing a web a channel-section glazing element, the inner glazing element can form a seal. In some embodiments the seal is also able to absorb any vibration that the glazing may experience, for example due to wind load or an impact on one of the major surfaces of the glazing.

Accordingly, glazings comprising first and second channel-section glazing elements arranged to define a cavity in which an inner glazing element is located are described. An end of a first flange of the first channel-section glazing element is spaced apart from a web of the second channel-section glazing element by a first space. The inner glazing element comprises a central portion, a first edge portion running along a first side of the central portion and a second edge portion running along a second opposite side of the central portion. A first portion of the first edge portion is positioned in the first space and is compressed by the end of the first flange of the first channel-section glazing element being positioned relative to the web of the second channel-section glazing element to form the first space.

1.-25. (canceled)

26. A glazing comprising a first channel-section glazing element and a second channel-section glazing element, the first and second channel-section glazing elements each comprising a web and a first flange, the first flange running along a first lateral edge of the respective web, the first and second channel-section glazing elements being arranged such that an end of the first flange of the first channel-section glazing element faces the web of the second channel-section glazing element, the end of the first flange of the first channel-section glazing element being positioned at a distance relative to the web of second channel-section glazing element such that the end of the first flange of the first channel-section glazing element is spaced apart from the web of the second channel-section glazing element by a first space,
wherein at least a portion of an inner glazing element is located between the web of the first channel-section glazing element and the web of the second channel-section glazing element,
the inner glazing element comprising:
a central portion,
a first edge portion running along a first side of the central portion and
a second edge portion running along a second side of the central portion,
the first side of the central portion being opposite the second side of the central portion;
wherein a first portion of the first edge portion of the inner glazing element is positioned in the first space between the end of the first flange of the first channel-section glazing element and the web of the second channel-section glazing element;
further wherein the first portion of the first edge portion of the inner glazing element is compressed by the end of the first flange of the first channel-section glazing element being positioned relative to the web of the second channel-section glazing element to form the first space.

27. The glazing according to claim 26, wherein the first portion of the edge portion of the inner glazing element is reversibly compressed.

28. The glazing according to claim 27, wherein upon increasing the distance of the first flange of the first channel-section glazing element relative to the web of the second channel-section glazing element such that the end of the first flange of the first channel-section glazing element is spaced apart from the web of the second channel-section glazing element by a second space, the first portion of the first edge portion of the inner glazing element expands to fill the second space.

29. The glazing according to claim 26, wherein the first portion of the edge portion of the inner glazing element is irreversibly compressed.

30. The glazing according to claim 26, wherein the central portion of the inner glazing element is made from a first material having a first chemical composition and the first edge portion of the inner glazing element is made from a second material having a second chemical composition, further wherein the first chemical composition is the same as the second chemical composition or wherein the first chemical composition is different to the second chemical composition.

31. The glazing according to claim 30, wherein the first edge portion of the inner glazing element is bonded to the central portion of the inner glazing element or wherein the first edge portion of the inner glazing element is integrally formed with the central portion of the inner glazing element.

32. The glazing according to claim 31, wherein the first edge portion of the inner glazing element is bonded to the central portion of the inner glazing element by being fused therewith or thereto, optionally wherein the first edge portion of the inner glazing element is thermally fused with or to the central portion of the inner glazing element.

33. The glazing according to claim 31, wherein the first edge portion of the inner glazing element is bonded to the central portion of the inner glazing element by an adhesive, optionally a permanent adhesive or a re-stickable adhesive; or by a mechanical fastener, optionally a hook and loop fastener.

34. The glazing according to claim 26, wherein the first edge portion of the inner glazing element comprises at least a first cavity, and wherein when the first portion of the first edge portion of the inner glazing element is compressed, the shape of the first cavity changes.

35. The glazing according to claim 26, wherein the first edge portion of the inner glazing element comprises a plastic material, optionally polyvinyl chloride, polyethylene polycarbonate or acrylic; or wherein the first edge portion of the inner glazing element comprises an elastomer, optionally silicone rubber, ethylene propylene diene monomer (EPDM) or neoprene; or wherein the first portion of the first edge portion of the inner glazing element comprises a resilient portion.

36. The glazing according to claim 26, wherein the first edge portion of the inner glazing element comprises a fibre insulation material, optionally wherein the first edge portion of the inner glazing element and/or the fibre insulation material comprises glass fibres and/or synthetic fibres.

37. The glazing according to claim 26, wherein the central portion of the inner glazing element comprises a plastic material, optionally polyvinyl chloride, polyethylene polycarbonate or acrylic; or wherein the central portion of the inner glazing element comprises an elastomer, optionally silicone rubber, ethylene propylene diene monomer (EPDM) or neoprene.

38. The glazing according to claim 26, wherein the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element; or wherein the central portion of the inner glazing element comprises a fibre insulation material, optionally wherein the central portion of the inner glazing element and/or the fibre insulation material comprises glass fibres and/or synthetic fibres.

39. The glazing according to claim 26, wherein the distance of the end of the first flange of the first channel-section glazing element from the web of second channel-section glazing element is greater than 1 mm and/or less than 50 mm, optionally greater than 1 mm and/or less than 30 mm.

40. The glazing according to claim 26, wherein an end of the first flange of the second channel-section glazing element faces the web of the first channel-section glazing element such that the end of the first flange of the second channel-section glazing element is positioned at a distance relative to the web of second channel-section glazing element such that the end of the first flange of the second channel-section glazing element is spaced apart from the web of the first channel-section glazing element by a second space.

41. The glazing according to claim 26, wherein the web of the first channel-section glazing element has a second flange running along a second lateral edge thereof, the second lateral edge of the web of the first channel-section glazing element being opposite the first lateral edge of the web of the first channel-section glazing element, optionally wherein the first channel-section glazing element has a U-shaped profile; and/or wherein the web of the second channel-section glazing element has a second flange running along a second lateral edge thereof, the second lateral edge of the web of the second channel-section glazing element being opposite the first lateral edge of the web of the second channel-section glazing element, optionally wherein the second channel-section glazing element has a U-shaped profile.

42. An inner glazing element for a glazing according to claim 26, the inner glazing element comprising:
a central portion,
a first edge portion running along a first side of the central portion; and
a second edge portion running along a second side of the central portion,
the first side of the central portion being opposite the second side of the central portion,
the central portion of the inner glazing element having a first major surface, a second major surface and a thickness, a thickness of the central portion of the inner glazing element being the spacing of the first and second major surfaces of the central portion of the inner glazing element;
the first edge portion of the inner glazing element having a thickness in a direction parallel to the thickness of the central portion of the inner glazing element, wherein the thickness of the first edge portion of the inner glazing element is less than the thickness of the central portion of the inner glazing element;
further wherein the first edge portion of the inner glazing element is bonded to the central portion of the inner glazing element and/or integrally formed therewith; and
wherein the first edge portion of the inner glazing element comprises at least a first compressible portion.

43. The inner glazing element according to claim 42, wherein the second edge portion of the inner glazing element has a thickness in a direction parallel to the thickness of the central portion, wherein the thickness of the second edge portion of the inner glazing element is less than the thickness of the central portion of the inner glazing element; further wherein the second edge portion of the inner glazing element is bonded to the central portion of the inner glazing element and/or integrally formed therewith; and wherein the second edge portion of the inner glazing element comprises at least a first compressible portion.

44. The inner glazing element according to claim 42, wherein the central portion of the inner glazing element comprises polycarbonate, polyester, or acrylic; or a bunch of fibres or a fibre insulation material; and/or wherein the first and/or second edge portions of the inner glazing element comprise polyvinyl chloride (PVC) ethylene vinyl acetate (EVA), polyester, polycarbonate, a polyolefin, an elastomer, or polyurethane.

45. The inner glazing element according to claim 42, wherein the first and/or second edge portion of the inner glazing element comprise at least a respective first cavity having a first shape, and wherein upon compressing the first and/or second edge portion having the respective first cavity therein, the shape of the respective first cavity changes.
